(19) United States
(12) Patent Application Publication
(10) Pub. No.: US 2026/0148667 A1
(43) Pub. Date: May 28, 2026

(54) Display Device and Electronic Device Including the Same

(71) Applicant: LG Display Co., Ltd., Seoul (KR)

(72) Inventor: Jung-Gyum Kim, Gimpo-si (KR)

(21) Appl. No.: 19/331,833

(22) Filed: Sep. 17, 2025

(30) Foreign Application Priority Data
Nov. 26, 2024 (KR) 10-2024-0171492

(51) Int. Cl. G09G 3/00; G02B 27/00; G02B 27/01; G09G 3/20

(52) U.S. Cl. CPC G09G 3/002; G02B 27/0093; G02B 27/0172; G09G 3/2003; G09G 3/2055; G02B 2027/014; G09G 2310/08; G09G 2320/0233; G09G 2320/0276; G09G 2320/0673; G09G 2360/16

(57) ABSTRACT

A display device includes a timing controller which generates image data based on an input image corresponding to a user’s gaze. The display device further includes a display panel which displays an image based on the image data. The timing controller includes a mode controller which receives motion information corresponding to the user’s gaze and controls a driving mode based on a variance of the motion information corresponding to the user’s gaze change and the variance of the input image. The timing controller further includes an image processor which processes the input image. At least a part of a plurality of modules included in the image processor is deactivated according to the driving mode.

### CROSS-REFERENCE TO RELATED APPLICATIONS

This application claims the priority of Korean Patent Application No. 10-2024-0171492 filed on November 26, 2024, in the Korean Intellectual Property Office, the disclosure of which is incorporated herein by reference.

### BACKGROUND

### Field

The present disclosure relates to a display device and an electronic device including the same, and more particularly, to a display device which improves a user’s dizziness and an electronic device including the same.

### Description of the Related Art

Currently, in the current information era, a field of a display device which visually expresses electrical information signals is being rapidly developed. The display device may be implemented as a small, medium or large electronic device such as a television, a set-top box, a navigation, a video player, a Blu-ray player, a personal computer, a wearable device, a mobile phone and a Virtual Reality Display Device.

Meanwhile, virtual reality display devices have the advantage of being able to immerse users in an environment that replicates reality as it is. To this end, users of virtual reality display devices wear equipment that can exchange information, such as goggles, headsets, gloves, and special suits, and experience the virtual environment.

When a user uses a virtual reality display device, the human eye and the virtual reality display device are positioned closer than with a typical display device, so the degree to which the person visually perceives the screen becomes very large. However, when the motion of the human and the change of the screen in response to the motion do not match, so-called virtual-reality sickness (VR sickness) or dizziness may occur. Such a virtual reality sickness causes great discomfort to the VR users and is a problem that limits the time spent using VR.

### SUMMARY

An object to be achieved by the present disclosure is to provide a display device which reduces user’s dizziness and an electronic device including the same.

Objects of the present disclosure are not limited to the above-mentioned objects, and other objects, which are not mentioned above, can be clearly understood by those skilled in the art from the following descriptions.

According to an aspect of the present disclosure, there is provided a display device. The display device includes: a timing controller which generates image data based on an input image corresponding to a user’s gaze; and a display panel which displays an image based on the image data, wherein the timing controller includes: a mode controller which receives motion information corresponding to the user’s gaze and controls a driving mode based on a variance of the motion information corresponding to the user’s gaze change and the variance of the input image; and an image processor which processes the input image, and at least a part of a plurality of modules included in the image processor is deactivated according to the driving mode.According to another aspect of the present disclosure, there is provided an electronic device. The electronic device includes: a processor which generates an input image corresponding to a user’s gaze; a display device including a timing controller which rearranges the input image to generate image data and a display panel which displays an image based on the image data; and a sensor which detects motion information corresponding to the user’s gaze, wherein the timing controller includes: a mode controller which controls a driving mode of the display device based on the variance of the motion information corresponding to the user’s gaze change and the variance of the input image; and an image processor which processes the input image, and at least a part of a plurality of modules included in the image processor is deactivated according to the driving mode.

According to still another aspect of the present disclosure, there is provided an electronic device. The electronic device includes: a processor which generates an input image corresponding to a user’s gaze; a display device including a timing controller which rearranges the input image to generate image data and a display panel which displays an image based on the image data; a sensor which detects motion information corresponding to the user’s gaze; and a memory which stores at least one look-up table (LUT), wherein the timing controller includes: a mode controller which controls a driving mode of the display device based on the variance of the motion information corresponding to the user’s gaze change and the variance of the input image; and an image processor which processes the input image, and communication between at least a part of a plurality of modules included in the image processor and the memory is stopped, according to the driving mode.

Other detailed matters of the exemplary embodiments are included in the detailed description and the drawings.

According to the exemplary embodiment of the present disclosure, the electronic device may be driven in a first mode or a second mode, based on a variance of motion information and a variance of the input image according to the user’s gaze change.

According to the exemplary embodiment of the present disclosure, when the variance of the motion information is smaller than the first threshold value or when the variance of the motion information is equal to or larger than the first threshold value, but the variance of the input image is smaller than the second threshold value, the electronic device is driven in the first mode in which the image is displayed by performing the compensation algorithm for the input image. When the variance of the motion information is equal to or larger than the first threshold value and the variance of the input image is equal to or larger than the second threshold value, the electronic device is driven in the second mode in which the image is displayed without performing a separate compensation algorithm for the input image.

According to the exemplary embodiment of the present disclosure, the VR sickness or dizziness which may occur according to the motion of the user may be improved.

The effects according to the present disclosure are not limited to the contents exemplified above, and more various effects are included in the present specification.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating an electronic device according to an exemplary embodiment of the present disclosure;

FIG. 2 is a block diagram illustrating an electronic device according to an exemplary embodiment of the present disclosure;

FIG. 3 is a block diagram illustrating an example of a timing controller included in an electronic device of FIG. 2;

FIGS. 4A to 4C are views for explaining an example that an electronic device of FIG. 2 is driven; and

FIG. 5 is a flowchart illustrating a driving method of an electronic device according to an exemplary embodiment of the present disclosure;

### DETAILED DESCRIPTION OF THE EMBODIMENT

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, a display device according to exemplary embodiments of the present disclosure will be described in detail with reference to accompanying drawings.

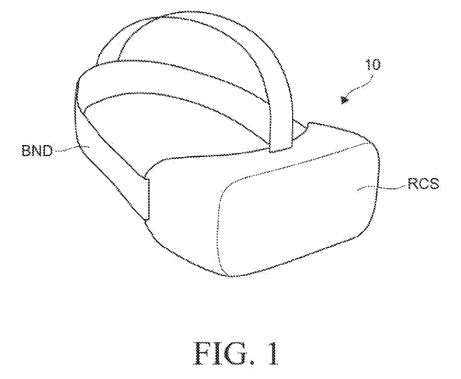

FIG. 1 is a view illustrating an electronic device according to an exemplary embodiment of the present disclosure;

Referring to FIG. 1, an electronic device 10 according to an exemplary embodiment of the present disclosure is implemented by a head mount display (HMD). The head mount display is an example of a wearable electronic device and is mounted on the user's head and can be implemented in a see-through form that provides augmented reality (AR) and/or a see-closed form that provides virtual reality (VR). However, this is just illustrative and the electronic device 10 may be implemented as various display devices, in addition to the head mount display.

As illustrated in FIG. 1, when the electronic device 10 is implemented as a head mount display, the electronic device 10 may include a storage case RCS and a band BND.

The storage case RCS stores a display device which is included in the electronic device 10 and displays an image.

The band BND may be fixed to the storage case RCS to enclose the top and both side surfaces of the user’s head, but is not limited thereto and a form and a shape of the band BAND may be modified. According to the exemplary embodiment, the band BND is provided to fix the head mount display to the head of the user and may be replaced with various other structures, such as a glass frame or a helmet.

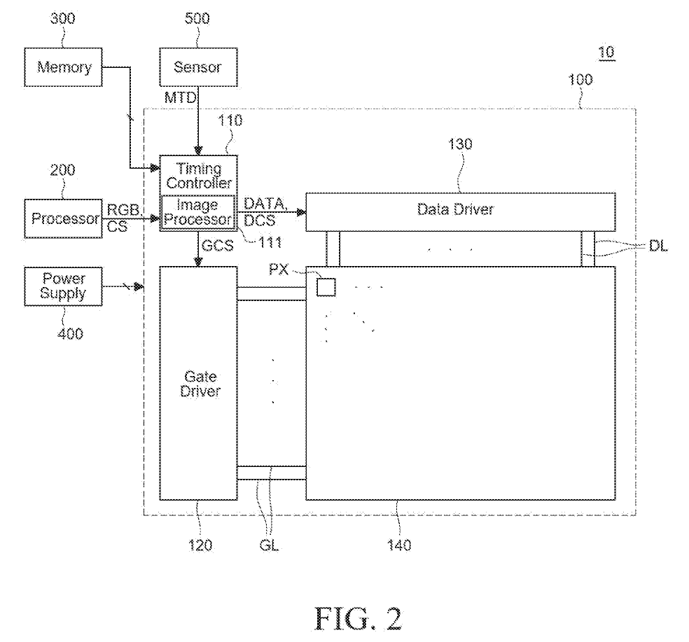

FIG. 2 is a block diagram illustrating an electronic device according to an exemplary embodiment of the present disclosure.

Referring to FIG. 2, the electronic device 10 according to the exemplary embodiment of the present disclosure includes a display device 100, a processor 200, a memory 300, a power supply unit 400, and a sensor 500.

The processor 200 may control the electronic device 10. For example, the processor 200 is connected to other configurations of the electronic device 10 through an interface, such as an address bus, a control bus, and a data bus. The processor 200 executes software to control at least one other component of the electronic device 10 connected to the processor 200, for example, a hardware or software component and performs various data processing or operation.

The processor 200 generates and outputs input image RGB. The processor 200 converts digital video data of the input image RGB to a format appropriate to be displayed by the display device 100 and outputs to the display device 100. Further, the processor 200 generates an input control signal CS to output the input control signal to the display device 100. For example, the input control signal CS includes timing signals, such as a horizontal synchronization signal, a vertical synchronization signal, a data enable signal, and a clock signal.

The display device 100 visually provides information to the outside (for example, a user) of the electronic device 10. To this end, a display device 100 includes a timing controller 110, a gate driver 120, a data driver 130, and a display panel 140.

The display panel 140 generates images to be provided to the user. For example, the display panel 140 includes a plurality of pixels PX in which pixel circuits are disposed, respectively. Each of the plurality of pixels PX is connected to a corresponding gate line GL and a corresponding data line DL to display images in response to a gate signal supplied to the gate line GL and a data signal supplied to the data line DL.

The timing controller 110 controls the gate driver 120 and the data driver 130 based on input image RGB and a control signal CS. For example, the timing controller 110 generates a gate control signal GCS and a data control signal DCS based on a control signal CS provided from the processor 200. The gate control signal GCS is supplied to the gate driver 120 and the data control signal DCS is supplied to the data driver 130.

Further, the timing controller 110 rearranges an input image RGB with a digital video data format provided from the processor 200 in accordance with a resolution of the display panel 140 to generate image data DATA and provide the image data to the data driver 130.

The timing controller 110 may include an image processor 111. The image processor 111 may process the input image RGB supplied from the processor 200. For example, the image processor 111 performs a compensation algorithm, for example, at least one of a luminance-based compensation algorithm and a voltage-based compensation algorithm, on the input image RGB. Accordingly, the image data DATA supplied to the data driver 130 may be generated by realigning the input image RGB to which the compensation algorithm is applied.

In the meantime, even though in FIG. 2, it is illustrated that the image processor 111 is included in the timing controller 110, the exemplary embodiment of the present disclosure is not limited thereto. For example, the image processor 111 may be included in the processor 200.

According to the exemplary embodiment, the timing controller 110 may be implemented by various circuits or electronic components, such as a field programmable gate array (FPGA), an integrated circuit (IC), or an application specific integrated circuit (ASIC). Further, the timing controller 110 may transmit or receive signals to and from other configurations through one or more predetermined interfaces and include a storage medium, such as one or more register. For example, the interface may include a low voltage differential signaling (LVDS) interface, an embedded clock point-to-point interface (EPI), or a serial peripheral interface (SPI), but is not limited thereto.

The gate driver 120 generates a gate signal based on the gate control signal GCS and outputs the gate signal to the plurality of gate lines GL. For example, the gate driver 120 sequentially outputs the gate signal to the plurality of gate lines GL.

The data driver 130 converts digital image data DATA supplied from the timing controller 110 into an analog data signal based on the data control signal DCS to supply the converted analog data signal to the plurality of data lines DL.

The memory 300 stores data required for the operation of the electronic device 10. For example, the memory may include a non-volatile memory device, such as a flash memory device, an erasable programmable read-only memory (EPROM) device, an electrically erasable programmable read-only memory(EEPROM) device, a phase change random access memory (PRAM) device, a resistance random access memory (RRAM) device, a nano floating gate memory (NFGM) device, a polymer random access memory (PoRAM) device, a magnetic random access memory (MRAM), a ferroelectric random access memory (FRAM) device and/or a volatile memory device, such as a double data rate (DDR) memory device, a dynamic random access memory (DRAM) device, a static random access memory (SRAM) device, or a mobile DRAM device, but is not limited thereto.

The memory 300 communicates with the other configuration of the electronic device 10, for example, the display device 100 or the processor 200, through a memory interface.

The power supply unit 400 supplies a driving voltage or current to the display device 100, for example, the timing controller 110, the display panel 140, the gate driver 120, and the data driver 130 and/or controls a supplied voltage or current. For example, the power supply unit 400 includes a power management integrated circuit (PICM).

The sensor 500 senses a motion of the electronic device 10 to detect and generate motion information MTD corresponding to the user’s gaze. For example, the sensor 500 may be a motion sensor including at least one of a gyro sensor, an acceleration sensor, and an inertia sensor, but is not limited thereto.

The sensor 500 may generate and output motion information MTD in every frame of the displayed image, but is not limited thereto. For example, the sensor 500 generates and outputs the motion information MTD at every half (1/2) frame of the displayed image or generates and outputs the motion information MTD at every two or more frames of the displayed image.

In the meantime, when the electronic device 10 is implemented as a head mount display as described with reference to FIG. 1, as compared with the general display device, the display device which displays an image of a virtual reality and/or augmented reality may be located very close to the user’s eye. In this case, a degree to which the user visually perceives the image increases relatively, but if the user's motion and the resulting screen change do not match, the user may experience VR sickness or dizziness. For example, when the user turns his or her head and a change in gaze occurs, the display device included in the electronic device should display an image corresponding to the changed gaze on the display panel. However, the image corresponding to the user's gaze may be displayed relatively late due to the time required for communication and signal processing of the display device, which may cause the user to experience virtual reality sickness.

Accordingly, when the movement of the electronic device 10, that is, the movement of the user’s gaze occurs, the electronic device 10 according to the exemplary embodiment of the present disclosure compares a variance of the motion information MTD with a first threshold value and compares a variance of the input image RGB with a second threshold value based on the motion information output from the sensor 500. According to the comparison result, the electronic device drives the electronic device 10 and/or the display device 100 in a first mode or a second mode.

For example, when the variance of the motion information MTD is smaller than the first threshold value or the variance of the motion information MTD is equal to or larger than the first threshold value, but the variance of the input image RGB is smaller than the second threshold value, the electronic device 10 drives the display device 100 in the first mode in which the image is displayed by performing the compensation algorithm on the input image RGB. In contrast, when the variance of the motion information MTD is equal to or larger than the first threshold value and the variance of the input image RGB is equal to or larger than the second threshold value, the electronic device 10 drives the display device 100 in the second mode in which the image is displayed without performing a separate compensation algorithm for the input image RGB. For example, all the plurality of modules included in the image processor 111 is activated in the first mode and at least some of the plurality of modules included in the image processor 111 is deactivated in the second mode.

Accordingly, when a change in the user's gaze occurs due to the user's motion and the change in the image corresponding to the change in gaze occurs beyond a predetermined reference, for example, when the degree of discrepancy between the user's motion and the resulting screen change occurs to cause the virtual reality sickness, the electronic device 10 according to the exemplary embodiment of the present disclosure may drive the display device 100 in the second mode in which the image is displayed without performing a separate compensation algorithm. In this case, a time required for the communication and the signal processing of the electronic device 10 or the display device 100 is reduced to improve an amount of the discrepancy between the user’s motion and the resulting screen change. Accordingly, the virtual reality sickness which may occur according to the user’s motion may be improved.

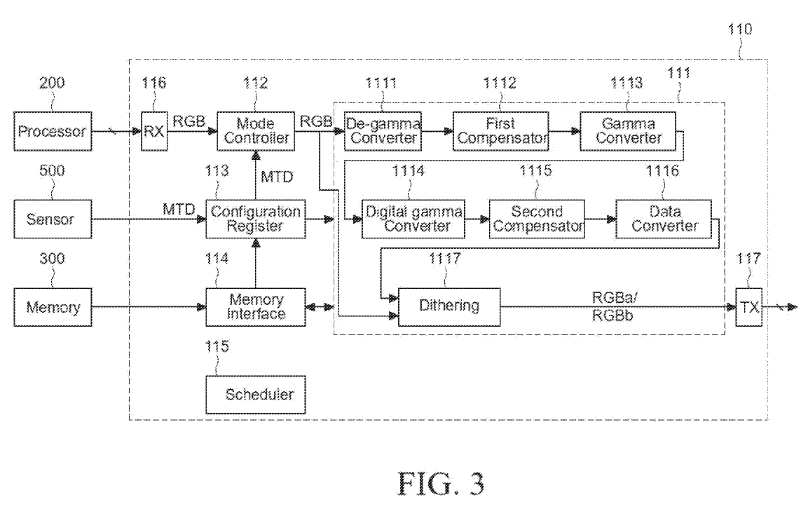

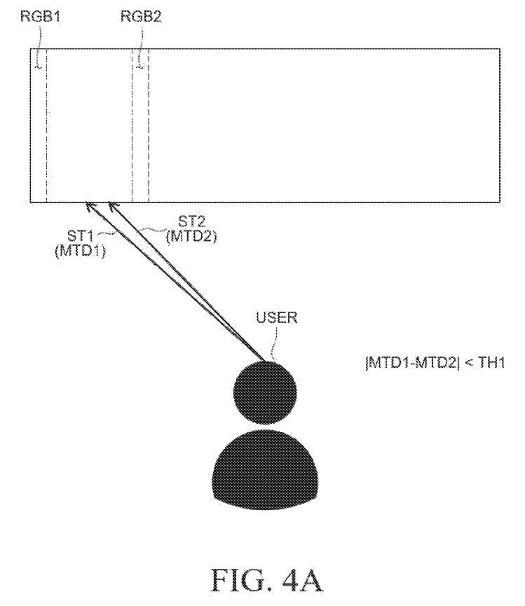

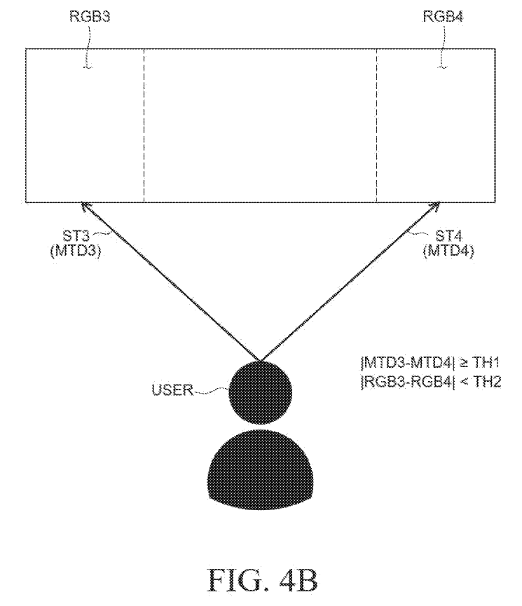

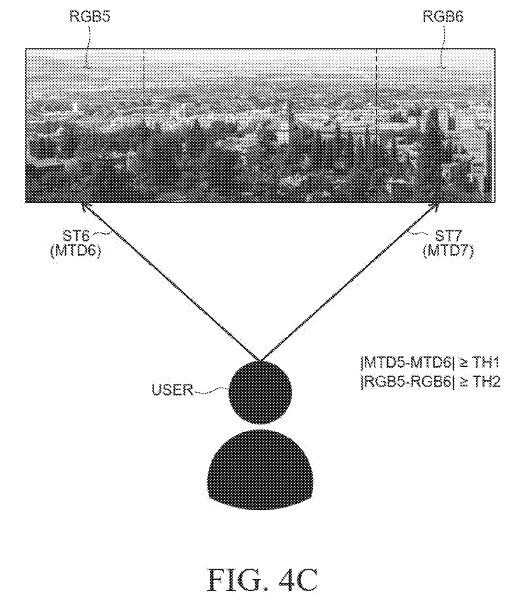

Hereinafter, a more specific description will be made with reference to FIGS. 3 to 4C.

FIG. 3 is a block diagram illustrating an example of a timing controller included in an electronic device of FIG. 2.

Referring to FIGS. 2 and 3, the timing controller 110 includes an image processor 111, a mode controller 112, a configuration register 113, a memory interface 114, a scheduler 115, a receiver 116, and a transmitter 117.

In the meantime, even though in FIG. 3, it is illustrated that the image processor 111, the mode controller 112, the configuration register 113, the memory interface 114, and the scheduler 115 are included in the timing controller, the exemplary embodiment of the present disclosure is not limited thereto. For example, at least one of the image processor 111, the mode controller 112, the configuration register 113, the memory interface 114, and the scheduler 115 is included in the processor 200.

The image processor 111 performs a compensation algorithm, for example, at least one of a luminance-based compensation algorithm and a voltage-based compensation algorithm, on the input image RGB.

To this end, in the exemplary embodiment, the image processor 111 includes a de-gamma converter 1111, a first compensator 1112, a gamma converter 1113, a digital gamma converter 1114, a second compensator 1115, a data converter 1116, and a dithering unit 1117, but is not limited thereto.

The de-gamma converter 1111 performs the de-gamma processing on grayscale data (pixel data) of the input image RGB. For example, the de-gamma converter 1111 converts the grayscale data of the input image RGB into luminance data based on a grayscale-luminance conversion look-up table (LUT, hereinafter, referred to as a "first look-up table”) supplied from the memory 300 through the memory interface 114.

The grayscale data of the input image RGB input to the de-gamma converter 1111 includes red grayscale data, green grayscale data, and blue grayscale data, but is not limited thereto. According to the exemplary embodiment, the de-gamma converter 1111 expands the number of bits for each color by considering the perceived luminance for red grayscale data, green grayscale data, and blue grayscale data, but is not limited thereto.

The first compensator 1112 receives luminance data of the input image RGB which is converted and output from the de-gamma converter 1111 and performs a first operation processing required for the luminance-based compensation algorithm on the luminance data of the input image RGB. For example, the luminance-based compensation algorithm includes a power consumption reduction algorithm, an afterimage compensation algorithm, and a color temperature compensation algorithm of the display device, but these are just illustrative and the exemplary embodiment of the present disclosure is not limited thereto.

The gamma converter 1113 receives the output data of the first compensator 1112, for example, the luminance data of the input image (RGB) on which the first operation processing required for the luminance-based compensation algorithm has been performed, and performs gamma processing on it. For example, the gamma converter 1113 converts the grayscale data of the input image RGB into luminance data again based on a luminance-grayscale conversion look-up table (LUT, hereinafter, referred to as a "second look-up table”) or a gamma corrected curve supplied from the memory 300 through the memory interface 114. Accordingly, the grayscale data of the input image RGB output from the gamma converter 1113 may be grayscale data to which the luminance-based compensation algorithm is applied.

The digital gamma converter 1114 performs digital gamma processing on output data of the gamma converter 1113, for example, the grayscale data (pixel data) of the input image RGB on which the luminance-based compensation algorithm is applied. For example, the digital gamma converter 1114 converts the grayscale data of the input image RGB into voltage data based on a grayscale-voltage conversion look-up table (LUT, hereinafter, referred to as a "third look-up table”) supplied from the memory 300 through the memory interface 114.

The second compensator 1115 receives voltage data of the input image RGB which is converted and output from the digital gamma converter 1114 and performs a second operation processing required for the voltage-based compensation algorithm on the voltage data of the input image RGB. For example, the voltage-based compensation algorithm includes an image display performance algorithm, a camera compensation algorithm, an afterimage compensation algorithm, and an external compensation algorithm of the display panel 140, but these are just illustrative and the exemplary embodiment of the present disclosure is not limited thereto.

The data converter 1116 receives the output data of the second compensator 1115, for example, the voltage data of the input image (RGB) on which the second operation processing required for the voltage-based compensation algorithm has been performed, and converts the voltage data into grayscale data again. For example, the data converter 1116 converts the voltage data of the input image RGB into the grayscale data into luminance data based on a voltage-luminance conversion look-up table (LUT, hereinafter, referred to as a "fourth look-up table”) supplied from the memory 300 through the memory interface 114. Accordingly, the grayscale data of the input image RGB output from the data converter 1116 may be grayscale data to which all the luminance-based compensation algorithm and the voltage-based compensation algorithm are applied.

In the above description, the de-gamma converter 1111, the gamma converter 1113, the digital gamma converter 1114, and the data converter 1116 have been described based on the conversion processing of the data domain based on the first look-up table, the second look-up table, the third look-up table, and the fourth look-up table received from the memory 300. However, the exemplary embodiment of the present disclosure is not limited thereto. For example, at least one of the de-gamma converter 1111, the gamma converter 1113, the digital gamma converter 1114, and the data converter 1116 may use a function equation for conversion processing of the data domain.

In the meantime, in at least a part of the data processing process of the de-gamma converter 1111, the first compensator 1112, the gamma converter 1113, the digital gamma converter 1114, the second compensator 1115, and the data converter 1116, the bit number of the digital data may be expanded or reduced. Here, when the bit number is reduced, a quantization error may occur due to the least significant bit (LSB). Accordingly, in some exemplary embodiments, at least one of the de-gamma converter 1111, the first compensator 1112, the gamma converter 1113, the digital gamma converter 1114, the second compensator 1115, and the data converter 1116 performs an error diffusion algorithm which reflects this error to the surrounding pixel data to improve the image quality.

The dithering unit 1117 performs a dithering operation for increasing a grayscale resolution of the input image RGB to output data of the input image RGB which is subject to the dithering operation through the transmitter 117. According to the exemplary embodiment, the dithering unit 1117 may perform at least one of a spatial dithering operation and a temporal dithering operation, but the present disclosure is not limited thereto. The spatial dithering operation adjusts grayscale data for adjacent pixels PX to express a gray scale of the bit number which is higher than a bit number of each grayscale data. The temporal dithering operation adjusts grayscale data in adjacent frames to express a gray scale of a bit number which is higher than a bit number of each gray scale data.

In one exemplary embodiment, the dithering unit 1117 performs the dithering operation on an input image RGB on which the compensation algorithm is performed or performs the dithering operation on an input image RGB on which the compensation algorithm is not performed, according to a driving mode of the electronic device 10 or the display device 100. For example, in the first mode of the display device 100, the dithering unit 1117 generates and outputs an input image (hereinafter, referred to as a “first compensated input image RGBa) obtained by performing a dithering operation on grayscale data of the input image RGB on which compensation algorithms, for example, a luminance-based compensation algorithm and a voltage-based compensation algorithm, according to a sequential operation of the de-gamma converter 1111, the first compensator 1112, the gamma converter 1113, the digital gamma converter 1114, the second compensator 1115, and the data converter 1116 are performed. As another example, in the second mode of the display device 100, the dithering unit 1117 directly receives the input image RGB from the mode controller 112 or the receiver 116 and generates and outputs an input image (hereinafter, a “second compensated input image RGBb) obtained by performing the dithering operation on the grayscale data of the corresponding input image RGB. With regard to this, it will be specifically described below together with the operation of the mode controller 112.

The mode controller 112 controls a driving mode of the electronic device 10 and/or the display device 100 based on the motion information MTD and the input image RGB.

For example, the mode controller 112 compares a variance of the motion information MTD supplied from the sensor 500 through the configuration register 113 with the first threshold value and compares a variance of the input image RGB supplied from the processor 200 through the receiver 116 with the second threshold value. Here, the first threshold value may be set as a minimum value of the position variance of the electronic device 10 where the VR sickness or dizziness occurs according to a degree of movement of the user’s gaze. The second threshold value may be set as a minimum value of a data variance of the input image RGB at which the VR sickness or the dizziness occurs according to a degree of the image variance depending on the movement of the user’s gaze. The first threshold value and the second threshold value may be set in advance based on the experiment, but these are just illustrative and the exemplary embodiment of the present disclosure is not limited thereto. The first threshold value and the second threshold value may be determined by calculation equations or algorithms which reflect human cognitive abilities.

In one exemplary embodiment, the mode controller 112 compares the variance of the motion information with the first threshold value and compares the variance of the input image RGB with the second threshold value at every frame of the display image. That is, the mode controller 112 determines a driving mode of the display device 100 at every frame of the display image. However, this is just illustrative so that the exemplary embodiment of the present disclosure is not limited thereto. For example, the mode controller 112 determines a driving mode of the display device 100 at every half (1/2) frame of the display image or determines a driving mode of the display device 100 at every two or more display images.

In one exemplary embodiment, the mode controller 112 drives the display device 100 in the first mode or the second mode based on the comparison result. For example, when the variance of the motion information MTD is equal to or larger than the first threshold value and the variance of the input image RGB is equal to or larger than the second threshold value, the mode controller 112 drives the display device 100 in the second mode and in the other cases, drives the display device 100 in the first mode.

For example, when the variance of the motion information MTD is smaller than the first threshold value, the mode controller 112 drives the display device 100 in the first mode in which the image is displayed by performing the compensation algorithm on the input image RGB. In this case, the image processor 111 performs a compensation algorithm, for example, at least one of the luminance-based compensation algorithm and the voltage-based compensation algorithm on the input image RGB, and generate and output a first compensated input image RGBa by performing the dithering operation on the compensated input image RGB.

Specifically, in the first mode of the display device 100, the mode controller 112 supplies the input image RGB received from the receiver 116 to the de-gamma converter 1111 of the image processor 111. In this case, the compensation algorithm, for example, the luminance-based compensation algorithm and the voltage-based compensation algorithm are performed according to a sequential operation of the de-gamma converter 1111, the first compensator 1112, the gamma converter 1113, the digital gamma converter 1114, the second compensator 1115, and the data converter 1116. The first compensated input image RGBa is generated and output by the operation of the dithering unit 1117. Accordingly, in the first mode of the display device 100, all components or modules which are included in the image processor 111 and perform the compensation algorithm sequentially operate to generate the first compensated input image RGBa.

Further, when the variance of the motion information MTD is equal to or larger than the first threshold value, but the variance of the input image RGB is smaller than the second threshold value, the mode controller 112 drives the display device 100 in the first mode in which the image is displayed by performing the compensation algorithm on the input image RGB. In this case, the image processor 111 performs a compensation algorithm, for example, at least one of the luminance-based compensation algorithm and the voltage-based compensation algorithm on the input image RGB, and generate and output a first compensated input image RGBa by performing the dithering operation on the compensated input image RGB.

In contrast, when the variance of the motion information MTD is equal to or larger than the first threshold value and the variance of the input image RGB is equal to or larger than the second threshold value, the mode controller 112 drives the display device 100 in the second mode in which the image is displayed without performing the separate compensation algorithm on the input image RGB. In this case, the image processor 111 performs only the dithering operation without performing a separate compensation algorithm on the input image RGB to generate and output a second compensated input image RGBb.

Specifically, in the second mode of the display device 100, the mode controller 112 supplies the input image RGB received from the receiver 116 to the dithering unit 1117 of the image processor 111. In this case, the de-gamma converter 1111, the first compensator 1112, the gamma converter 1113, the digital gamma converter 1114, the second compensator 1115, and the data converter 1116 are deactivated and are not operated. The dithering unit 117 directly receives the input image RGB from the mode controller 112 or the receiver 116 and generates and outputs the second compensated input image RGBb through the dithering operation. Accordingly, in the second mode of the display device 100, all components or modules which are included in the image processor 111 except for the dithering unit 1117 and perform the compensation algorithm are deactivated to generate the second compensated input image RGBb.

In the meantime, as described above, when a motion of a user who wears the electronic device 10 and a corresponding screen change do not match, the user may experience the VR sickness or dizziness. For example, depending on the human cognitive ability, human may need about 10 to 20 ms of time or latency to perceive the space or screen corresponding to the changed gaze according to the gaze movement. Accordingly, when a change in the user's gaze occurs due to the user turning his or her head, the display device 100 included in the electronic device 10 worn by the user needs to display an image corresponding to the user's changed gaze on the display panel 140 within 10 ms so that the user does not feel VR sickness or dizziness.

Here, when a change in the user's gaze occurs, the time (latency) when the changed image is displayed may correspond to the sum of the time (latency) for generating an input image RGB corresponding to the user's changed gaze from the processor 200, for example, the image processing time (latency) of the timing control unit 110, for example, the image processor 111. As a data variance of the image increases according to the change in the user's gaze, the time (latency) for generating the input image RGB corresponding to the changed gaze of the user from the processor 200 and the image processing time (latency) of the image processor 111 increase together, so that the user may experience VR sickness or dizziness.

Accordingly, in the case of the electronic device 10 according to the exemplary embodiment of the present disclosure, when the data variance of the image corresponding to the changed gaze when the user turns his or her head to cause the gaze change is equal to or larger than the predetermined value, that is, when the variance of the motion information MTD is equal to or larger than the first threshold value and the variance of the input image RGB is equal to or larger than the second threshold value, all components or modules which are included in the image processor 111 except for the dithering unit 117 and perform the compensation algorithm are deactivated. Therefore, a time required for data domain conversion processing of the input image RGB and the compensation algorithm application is shortened to suppress the VR sickness of the dizziness of the user according to the time variance.

In the meantime, when the user’s gaze is changed so that the image is changed, the user’s image quality cognitive ability may become relatively lower. Accordingly, as described above, in the second mode of the display device 100, even though a component or module which is included in the image processor 111 and performs the compensation algorithm is deactivated to relatively degrade the image quality, the user cannot perceive the degradation of the image quality.

Referring to FIG. 3 again, the configuration register 113 stores a configuration value or a configuration code of the timing controller 110 and the timing controller 110 controls each component or module according to the configuration value or the configuration code stored in the configuration register 113. For example, the image processor 111, the mode controller 112, and the memory interface 114 may be controlled according to the configuration value or the configuration code stored in the configuration register 113.

Further, the configuration register 113 receives and stores motion information MTD from the sensor 500 and supplies the motion information to the mode controller 112.

The memory interface 114 performs the communication of the timing controller 110 and the memory 300. For example, the memory interface 114 performs the communication of the image processor 111 and/or the configuration register 113 and the memory 300.

In one exemplary embodiment, the memory interface 114 supplies data required for the de-gamma converter 1111, the first compensator 1112, the gamma converter 1113, the digital gamma converter 1114, the second compensator 1115, and the data converter 1116 included in the image processor 111 from the memory 300 to the image processor 111. For example, the de-gamma converter 1111, the gamma converter 1113, the digital gamma converter 1114, and the data converter 1116 may receive the first look-up table, the second look-up table, the third look-up table, and the fourth look-up table from the memory 300 through the memory interface 114. The first compensator 1112 and the second compensator 1115 may receive data required for the compensation algorithm from the memory 300 through the memory interface 114.

Here, as described above, when the display device 100 is driven in the second mode, all the components or modules which are included in the image processor 111 except for the dithering unit 1117 and perform the compensation algorithm are deactivated. Therefore, the time for the communication between the de-gamma converter 1111, the first compensator 1112, the gamma converter 1113, the digital gamma converter 1114, the second compensator 1115, and the data converter 1116 and the memory 300 may also be saved. For example, when the memory 300 is implemented by a non-volatile memory device, such as a flash memory device, to store various compensation data, look-up tables, and algorithm control configuration values, a data communication time is longer than that of the volatile memory device. Further, even though the memory 300 is implemented by a volatile memory device, such as a DDR memory device, a high resolution image has a relatively large amount of image data so that longer data communication time is required. However, in the second mode of the display device 100, the components or modules of the image processor 111 are deactivated so that the time required for the communication between the image processor 111 and the memory 300 may also be reduced. Accordingly, the VR sickness or dizziness of the user over time may be more effectively suppressed.

The scheduler 115 is mechanically or electronically implemented. For example, the scheduler 115 is a sequence which is implemented by hardware circuits or generated by software and is implemented by instructions or register configurations. The scheduler 115 is connected to each component or module in the timing controller 110 to manage the component or module.

According to the exemplary embodiment, in the first mode of the display device 100 in which the compensation algorithm operation for the input image RGB is performed, a scheduler (core) operating of the scheduler 115 is performed. In the second mode of the display device 100 in which a separate compensation algorithm operation for the input image RGB is not performed, the scheduler shut-down of the scheduler 115 may occur.

FIGS. 4A to 4C are views for explaining an example that an electronic device of FIG. 2 is driven.

Referring to FIGS. 3 and 4A, when the user’s gaze moves from a first gaze ST1 to a second gaze ST2, a sensor 500 included in the electronic device 10 worn by the user generates first motion information MTD1 corresponding to the first gaze ST1 and second motion information MTD2 corresponding to the second gaze ST2.

Here, when the variance of the motion information MTD according to the user's gaze change, for example, the difference of the first motion information MTD1 and the second motion information MTD2 is smaller than the first threshold value TH1 (in FIG. 4A, denoted by “｜MTD1-MTD2｜<TH1”), the display device 100 is driven in the first mode.

In the meantime, when the variance of the motion information MTD according to the user’s gaze change is smaller than the first threshold value TH1, the display device 100 is driven in the first mode regardless of the variance of the input image RGB, for example, a difference of the first input image RGB1 corresponding to the first gaze ST1 and the second input image RGB2 corresponding to the second gaze ST2.

Next, referring to FIGS. 3 and 4B, when the user’s gaze moves from a third gaze ST3 to a fourth gaze ST4, the sensor 500 included in the electronic device 10 worn by the user generates third motion information MTD3 corresponding to a third gaze ST3 and fourth motion information MTD4 corresponding to a fourth gaze ST4.

Here, even though the variance of the motion information MTD according to the user's gaze change, for example, the difference of the third motion information MTD3 and the fourth motion information MTD4 is equal to or larger than the first threshold value TH1 (in FIG. 4B, denoted by “｜MTD3-MTD4｜≥TH1”), when the variance of the input image RGB, for example, the difference between a third input image RGB3 corresponding to a third gaze ST3 and a fourth input image RGB4 corresponding to a fourth gaze ST4 is smaller than the second threshold value TH2 (in FIG. 4B, denoted by “｜RGB3-RGB4｜<TH2”), the display device 100 may be driven in the first mode.

Next, referring to FIGS. 3 and 4C, when the user’s gaze moves from a fifth gaze ST5 to a sixth gaze ST6, the sensor 500 included in the electronic device 10 worn by the user generates fifth motion information MTD5 corresponding to a fifth gaze ST5 and sixth motion information MTD6 corresponding to the sixth gaze ST6.

Here, when the variance of the motion information MTD according to the user's gaze change, for example, the difference of the fifth motion information MTD5 and the sixth motion information MTD6 is equal to or larger than the first threshold value TH1 (in FIG. 4C, denoted by “｜MTD5-MTD6｜≥TH1”) and the variance of the input image RGB, for example, the difference between a fifth input image RGB5 corresponding to a fifth gaze ST5 and a sixth input image RGB6 corresponding to a sixth gaze ST6 is equal to or larger than the second threshold value TH2 (in FIG. 4C, denoted by “｜RGB5-RGB6｜≥TH2”), the display device 100 may be driven in the second mode. Accordingly, even though the variance of the image is large in accordance with the user’s gaze change, the time required for data domain conversion processing and compensation algorithm application of the input image RGB and the time required for the communication of the image processor 111 and the memory 300 are reduced. Therefore, the VR sickness or dizziness of the user according to the gaze change may be suppressed (removed).

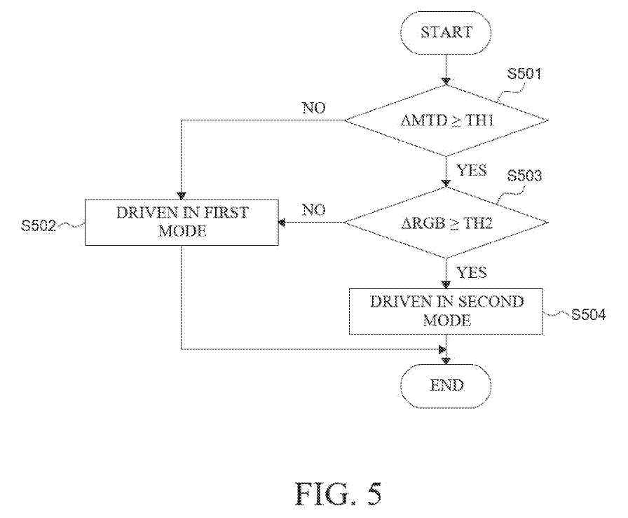

FIG. 5 is a flowchart illustrating a driving method of a display device according to an exemplary embodiment of the present disclosure.

Referring to FIGS. 2 to 5, a driving method of the electronic device of FIG. 5 is performed on the electronic device 10 which has been described with reference to FIGS. 2 to 4. For example, the driving method of the electronic device of FIG. 5 may be substantially the same as the operation of the timing controller 110 which has been described with reference to FIGS. 2 to 4C. Accordingly, a repeated description with the content which has been described with reference to FIGS. 2 to 4C will not be repeated.

First, referring to FIG. 5, according to the driving method of the electronic device of FIG. 5, a variance ΔMTD of the motion information MTD and the first threshold value TH1 are compared (S501).

Here, when the variance ΔMTD of the motion information MTD is smaller than the first threshold value TH1, in the driving method of the electronic device of FIG. 5, the electronic device 10 or the display device 100 may be driven in the first mode (S502).

Here, when the variance ΔMTD of the motion information MTD is equal to or larger than the first threshold value TH1, in the driving method of the electronic device of FIG. 5, the variance ΔRGB of the input image RGB and a second threshold value TH2 are compared (S503).

Here, when the variance ΔRGB of the input image RGB is smaller than the second threshold value TH2, in the driving method of the electronic device of FIG. 5, the electronic device 10 or the display device 100 may be driven in the first mode (S502).

In contrast, when the variance ΔRGB of the input image RGB is equal to or larger than the second threshold value TH2, in the driving method of the electronic device of FIG. 5, the electronic device 10 or the display device 100 may be driven in the second mode (S504).

The exemplary embodiments of the present disclosure can also be described as follows:

According to an aspect of the present disclosure, there is provided a display device. The display device includes a timing controller which generates image data based on an input image corresponding to a user’s gaze. The display device further includes a display panel which displays an image based on the image data. The timing controller includes a mode controller which receives motion information corresponding to the user’s gaze and controls a driving mode based on a variance of the motion information corresponding to the user’s gaze change and the variance of the input image. The timing controller further includes an image processor which processes the input image. At least a part of a plurality of modules included in the image processor is deactivated according to the driving mode.

In a first mode in which a variance of the motion information is smaller than a first threshold value or a variance of the input image is smaller than a second threshold value, all the plurality of modules included in the image processor may be activated. In a second mode in which the variance of the motion information is equal to or larger than the first threshold value or the variance of the input image is equal to or larger than the second threshold value, at least a part of the plurality of modules included in the image processor may be deactivated.

According to another aspect of the present disclosure, there is provided an electronic device. The electronic device includes a processor which generates an input image corresponding to a user’s gaze. The electronic device further includes: a display device including a timing controller which rearranges the input image to generate image data and a display panel which displays an image based on the image data. The electronic device further includes a sensor which detects motion information corresponding to the user’s gaze. The timing controller includes a mode controller which controls a driving mode of the display device based on the variance of the motion information corresponding to the user’s gaze change and the variance of the input image. The timing controller includes an image processor which processes the input image. At least a part of a plurality of modules included in the image processor is deactivated according to the driving mode.

When a variance of the motion information is smaller than a first threshold value or a variance of the input image is smaller than a second threshold value, the mode controller may drive the display device in a first mode. When the variance of the motion information is equal to or larger than the first threshold value and the variance of the input image is equal to or larger than the second threshold value, the mode controller may drive the display device in a second mode.

In the first mode, all a plurality of modules included in the image processor may be activated. And in the second mode, at least a part of the plurality of modules included in the image processor may be deactivated.

The image processor may include a de-gamma converter which converts grayscale data of the input image into luminance data. The image processor may further include a first compensator which performs a first operation processing on the luminance data of the input image output from the de-gamma converter. The image processor may further include a gamma converter which converts the luminance data of the input image on which the first operation processing is performed into grayscale data. The image processor may further include a digital gamma converter which converts the grayscale data of the input image output from the gamma converter into voltage data. The image processor may further include a second compensator which performs a second operation processing on the voltage data of the input image output from the digital gamma converter. The image processor may further include a data converter which converts the voltage data of the input image on which the second operation processing is performed into grayscale data. And the image processor may further include a dithering unit which performs dithering on the grayscale data of the input image output from the data converter.

In the first mode, all the de-gamma converter, the first compensator, the gamma converter, the digital gamma converter, the second compensator, and the data converter may be activated.

In the first mode, the input image output from the processor may be supplied to the de-gamma converter.

In the second mode, at least one of the de-gamma converter, the first compensator, the gamma converter, the digital gamma converter, the second compensator, and the data converter may be deactivated.

In the second mode, the input image output from the processor may be supplied to the dithering unit.

The electronic device may further include a memory which stores at least one look-up table (LUT). And the timing controller may further include a memory interface which performs communication between the memory and the image processor.

In the first mode, all the de-gamma converter, the first compensator, the gamma converter, the digital gamma converter, the second compensator, and the data converter may communicate with the memory through the memory interface.

In the second mode, communication between at least one of the de-gamma converter, the first compensator, the gamma converter, the digital gamma converter, the second compensator, and the data converter and the memory may be stopped.

The memory may include a first look-up table for grayscale-luminance domain conversion of the input image. The memory may further include a second look-up table for luminance-grayscale domain conversion of the input image. The memory may further include a third look-up table for grayscale-voltage domain conversion of the input image. The memory may further include a fourth look-up table for voltage-grayscale domain conversion of the input image.

The first look-up table may be supplied to the de-gamma converter through the memory interface, the second look-up table may be supplied to the gamma converter through the memory interface, the third look-up table may be supplied to the digital gamma converter through the memory interface, and the fourth look-up table may be supplied to the data converter through the memory interface.

According to still another aspect of the present disclosure, there is provided an electronic device. The electronic device includes a processor which generates an input image corresponding to a user’s gaze. The electronic device further includes a display device including a timing controller which rearranges the input image to generate image data and a display panel which displays an image based on the image data. The electronic device further includes a sensor which detects motion information corresponding to the user’s gaze. The electronic device further includes a memory which stores at least one look-up table (LUT). The timing controller includes a mode controller which controls a driving mode of the display device based on the variance of the motion information corresponding to the user’s gaze change and the variance of the input image. The timing controller further includes an image processor which processes the input image. And communication between at least a part of a plurality of modules included in the image processor and the memory is stopped, according to the driving mode.

When a variance of the motion information is smaller than a first threshold value or a variance of the input image is smaller than a second threshold value, the mode controller may drive the display device in a first mode. When the variance of the motion information is equal to or larger than the first threshold value or the variance of the input image is equal to or larger than the second threshold value, the mode controller may drive the display device in a second mode.

In the first mode, all a plurality of modules included in the image processor may communicate with the memory and in the second mode, communication between at least a part of the plurality of modules included in the image processor and the memory may be stopped.

The memory may include a first look-up table for grayscale-luminance domain conversion of the input image. The memory may further include a second look-up table for luminance-grayscale domain conversion of the input image. The memory may further include a third look-up table for grayscale-voltage domain conversion of the input image. And the memory may further include a fourth look-up table for voltage-grayscale domain conversion of the input image.

The image processor may include a de-gamma converter which converts the grayscale data of the input image into luminance data based on the first look-up table. The image processor may further include a first compensator which performs first operation processing on the luminance data of the input image output from the de-gamma converter. The image processor may further include a gamma converter which converts the luminance data of the input image on which the first operation processing is performed into grayscale data, based on the second look-up table. The image processor may further include a digital gamma converter which converts the grayscale data of the input image output from the gamma converter into voltage data based on the third look-up table. The image processor may further include a second compensator which performs a second operation processing on the voltage data of the input image output from the digital gamma converter. The image processor may further include a data converter which converts the voltage data of the input image on which the second operation processing is performed into grayscale data, based on the fourth look-up table. And the image processor may further include a dithering unit which performs dithering on the grayscale data of the input image output from the data converter.

What is claimed is:

1. A display device, comprising:
a timing controller which generates image data based on an input image corresponding to a user’s gaze; and
a display panel which displays an image based on the image data,
wherein the timing controller includes:
a mode controller which receives motion information corresponding to the user’s gaze and controls a driving mode based on a variance of the motion information corresponding to change in the user’s gaze and variance of the input image corresponding to change in the user’s gaze; and
an image processor which processes the input image, and
wherein at least a part of a plurality of modules included in the image processor is deactivated according to the driving mode.

2. The display device according to claim 1, wherein in a first mode in which the variance of the motion information is smaller than a first threshold value or the variance of the input image is smaller than a second threshold value, all of the plurality of modules included in the image processor are activated and in a second mode in which the variance of the motion information is equal to or larger than the first threshold value or the variance of the input image is equal to or larger than the second threshold value, at least a part of the plurality of modules included in the image processor is deactivated.

3. An electronic device, comprising:
a processor which generates an input image corresponding to a user’s gaze;
a display device including a timing controller which rearranges the input image to generate image data and a display panel which displays an image based on the image data; and
a sensor which detects motion information corresponding to the user’s gaze,
wherein the timing controller includes:
a mode controller which controls a driving mode of the display device based on a variance of the motion information corresponding to change in the user’s gaze and variance of the input image; and
an image processor which processes the input image, and
wherein at least a part of a plurality of modules included in the image processor is deactivated according to the driving mode.

4. The electronic device according to claim 3, wherein when the variance of the motion information is smaller than a first threshold value or the variance of the input image is smaller than a second threshold value, the mode controller drives the display device in a first mode and when the variance of the motion information is equal to or larger than the first threshold value and the variance of the input image is equal to or larger than the second threshold value, the mode controller drives the display device in a second mode.

5. The electronic device according to claim 4, wherein in the first mode, all of the plurality of modules included in the image processor are activated and in the second mode, at least a part of the plurality of modules included in the image processor is deactivated.

6. The electronic device according to claim 4, wherein the image processor includes:
a de-gamma converter which converts grayscale data of the input image into luminance data;
a first compensator which performs a first operation processing on the luminance data of the input image output from the de-gamma converter;
a gamma converter which converts the luminance data of the input image on which the first operation processing is performed into grayscale data;
a digital gamma converter which converts the grayscale data of the input image output from the gamma converter into voltage data;
a second compensator which performs a second operation processing on the voltage data of the input image output from the digital gamma converter;
a data converter which converts the voltage data of the input image on which the second operation processing is performed into grayscale data; and
a dithering unit which performs dithering on the grayscale data of the input image output from the data converter.

7. The electronic device according to claim 6, wherein in the first mode, all the de-gamma converter, the first compensator, the gamma converter, the digital gamma converter, the second compensator, and the data converter are activated.

8. The electronic device according to claim 6, wherein in the first mode, the input image output from the processor is supplied to the de-gamma converter.

9. The electronic device according to claim 6, wherein in the second mode, at least one of the de-gamma converter, the first compensator, the gamma converter, the digital gamma converter, the second compensator, and the data converter is deactivated.

10. The electronic device according to claim 6, wherein in the second mode, the input image output from the processor is supplied to the dithering unit.

11. The electronic device according to claim 6, further comprising:
a memory which stores at least one look-up table (LUT),
wherein the timing controller further includes a memory interface which performs communication between the memory and the image processor.

12. The electronic device according to claim 11, wherein in the first mode, all the de-gamma converter, the first compensator, the gamma converter, the digital gamma converter, the second compensator, and the data converter communicate with the memory through the memory interface.

13. The electronic device according to claim 11, wherein in the second mode, communication between at least one of the de-gamma converter, the first compensator, the gamma converter, the digital gamma converter, the second compensator, and the data converter and the memory is stopped.

14. The electronic device according to claim 11, wherein the memory includes:
a first look-up table for grayscale-luminance domain conversion of the input image;
a second look-up table for luminance-grayscale domain conversion of the input image;
a third look-up table for grayscale-voltage domain conversion of the input image; and
a fourth look-up table for voltage-grayscale domain conversion of the input image.

15. The electronic device according to claim 14, wherein the first look-up table is supplied to the de-gamma converter through the memory interface, the second look-up table is supplied to the gamma converter through the memory interface, the third look-up table is supplied to the digital gamma converter through the memory interface, and the fourth look-up table is supplied to the data converter through the memory interface.

16. An electronic device, comprising:
a processor which generates an input image corresponding to a user’s gaze;
a display device including a timing controller which rearranges the input image to generate image data and a display panel which displays an image based on the image data;
a sensor which detects motion information corresponding to the user’s gaze; and
a memory which stores at least one look-up table (LUT),
wherein the timing controller includes:
a mode controller which controls a driving mode of the display device based on variance of the motion information corresponding to change in the user’s gaze and variance of the input image; and
an image processor which processes the input image, and
communication between at least a part of a plurality of modules included in the image processor and the memory is stopped, according to the driving mode.

17. The electronic device according to claim 16, wherein when the variance of the motion information is smaller than a first threshold value or the variance of the input image is smaller than a second threshold value, the mode controller drives the display device in a first mode and when the variance of the motion information is equal to or larger than the first threshold value or the variance of the input image is equal to or larger than the second threshold value, the mode controller drives drives the display device in a second mode.

18. The electronic device according to claim 17, wherein in the first mode, all of the plurality of modules included in the image processor communicate with the memory and in the second mode, communication between at least a part of the plurality of modules included in the image processor and the memory is stopped.

19. The electronic device according to claim 17, wherein the memory includes:
a first look-up table for grayscale-luminance domain conversion of the input image;
a second look-up table for luminance-grayscale domain conversion of the input image;
a third look-up table for grayscale-voltage domain conversion of the input image; and
a fourth look-up table for voltage-grayscale domain conversion of the input image.

20. The electronic device according to claim 19, wherein the image processor includes:
a de-gamma converter which converts the grayscale data of the input image into luminance data based on the first look-up table;
a first compensator which performs first operation processing on the luminance data of the input image output from the de-gamma converter;
a gamma converter which converts the luminance data of the input image on which the first operation processing is performed into grayscale data, based on the second look-up table;
a digital gamma converter which converts the grayscale data of the input image output from the gamma converter into voltage data based on the third look-up table;
a second compensator which performs a second operation processing on the voltage data of the input image output from the digital gamma converter;
a data converter which converts the voltage data of the input image on which the second operation processing is performed into grayscale data, based on the fourth look-up table; and
a dithering unit which performs dithering on the grayscale data of the input image output from the data converter.
